(19) United States
(12) Patent Application Publication
(10) Pub. No.: US 2005/0258946 A1
(43) Pub. Date: Nov. 24, 2005

(54) Motor vehicle guard wireless infrared alert system

(76) Inventor: Sadiki Jason Forte, Silver Spring, MD (US)

Correspondence Address: Sadiki Jason Forte, 14404 Cantrell Rd., Silver Spring, MD, 20905, US

(21) Appl. No.: 10/849,572

(22) Filed: May 21, 2004

(51) Int. Cl. B60R 25/10

(52) U.S. Cl. 340/426.24; 340/556

(57) ABSTRACT

It is an object of the present invention to automatically detect the movement under and around a vehicles driver's seat. Once activated if the device is disrupted or disturbed an alert signal will transmit the signal to monitoring receiver sensors, causing the alarm to be triggered. With respect to the electronics of the system, it has been found to be advantages to provide the detector with an amplifier and a microprocessor for processing the amplified signal from the detector and programmed to define a range of the infrared radiation such that false activation by environmental and other spurious influences can be suppressed. Although movement may be detected by infrared sensing means, an alarm is not triggered unless the alarm has been activated. The on/off switch provides the owner of the vehicle the means of activating the alarm when intrusion or movement is expected during that time period.

### BACKGROUND OF THE INVENTION

### FIELD OF THE INVENTION

The present invention relates to an intrusion detecting apparatus for a vehicle, and particularly to an intrusion detecting apparatus for a vehicle to detect an illegal intrusion of a person into a vehicle by utilizing a disseminating Infrared transmitting/receiver device, which is placed under the driver's car seat creating an Infrared protective barrier around the bottom of the driver's seat particularly the driver's foot peddles.

### DESCRIPTION OF SPESIFICATION

An wireless automotive security alert system in which an infrared disseminating sensor located under the drivers seat of the vehicle placed towards the foot peddles detects an unauthorized persons who is attempting to operate a vehicle, operating on disposable batteries and using the Fresnel lens to bend the infrared disseminating beams which are set at a predetermined field of view to cover every conceivable angle under the drivers seat, with a detection range of no less than 2 inches. Once activated the device will have no less than two disseminating Infrared beams in use. The Motor Vehicle Guard also includes Home and Key chain receiver units for twenty-four hour vehicle monitoring. The wireless Home Receiver Unit is powered by disposable batteries or a DC adaptor, the Key Chain Receiver Unit is only powered by disposable batteries. Once activated the Home Receiver Unit allows its owners to control the volume of the device through the use of a volume scroll for personal preferences. The Key Chain Receiver Unit has a beep or vibrate function for privacy, both devices have a detection range of no less than 400 feet allowing its owners to monitor their vehicles over a limited range. If anyone of the Motor Vehicle Guards Infrared beams are disturbed or broken then it will transmit a signal from the vehicle into the Home receiver Unit or the Key Chain Unit or both triggering a preset flashing signal and an alerting sound, witch alerts owners of the devices disturbance, giving them the opportunity to either investigate the vehicles intrusion privately or to phone the police, both actions would be unknown to the unsuspecting car thief, increasing the chances of apprehension. The device can be shaped in the form of a circle, oval, triangle, rectangle, square, octagon, diamond, horseshoe, clover, star or any other closely related shapes.

### BRIEF DESCRIPTION OF DRAWINGS

The invention will now be described by way of example, with reference to the accompanying drawings in which:

Page Number: 2

FIG. 1 is a partial section in the region of under a vehicles driver's seat and a diagram of the security system of the invention from a top view.

Page Number: 4

FIG. 2 is a diagram of how the disseminating infrared beams detect illegal intrusion within a motor vehicle.

Page Number: 7, 9

FIG. 3 is a diagram of how the home/Key chain or portable receivers alert system functions with reference to the Infrared transmission signal.

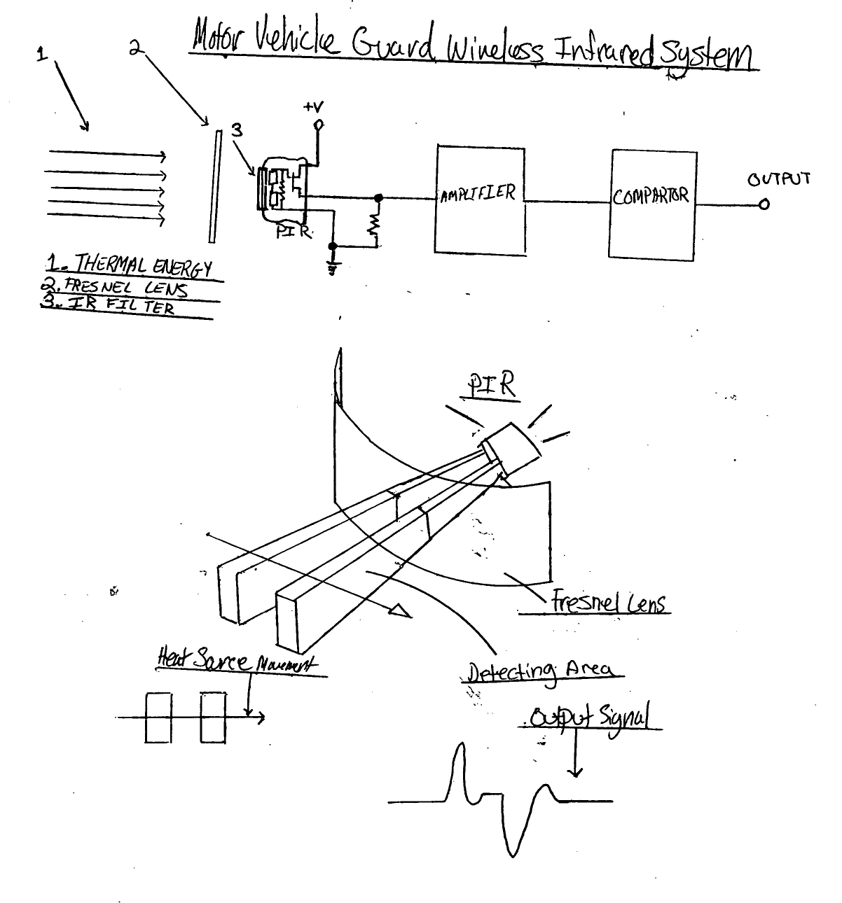

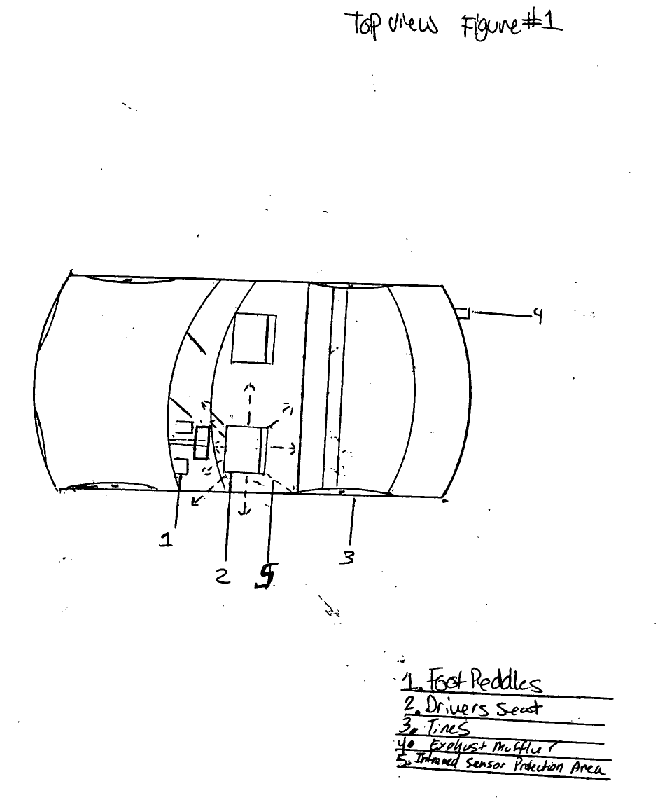

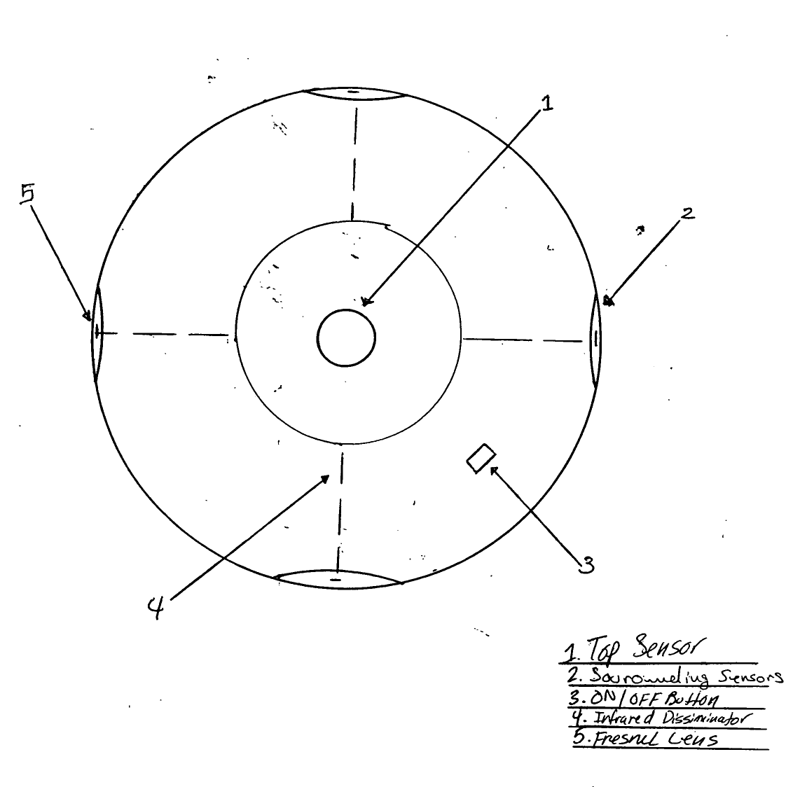

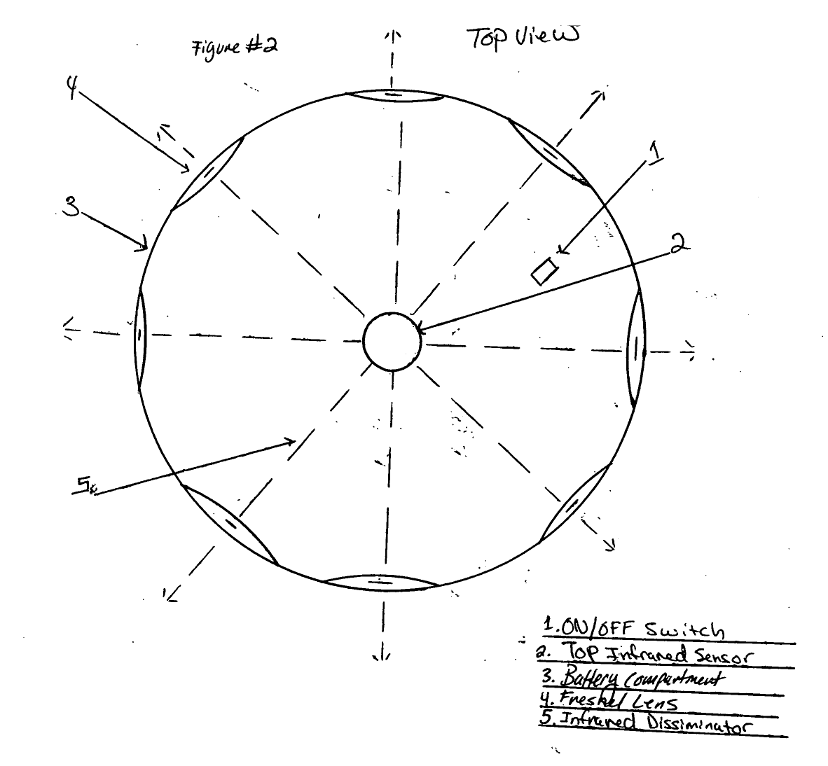

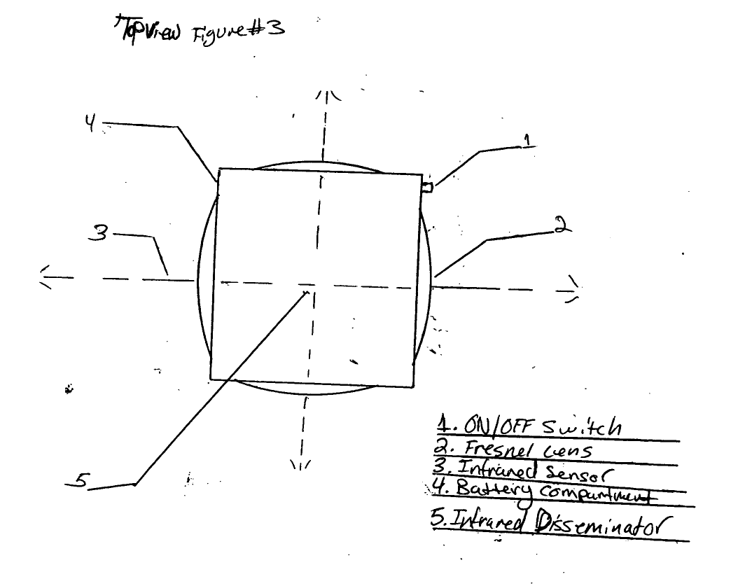

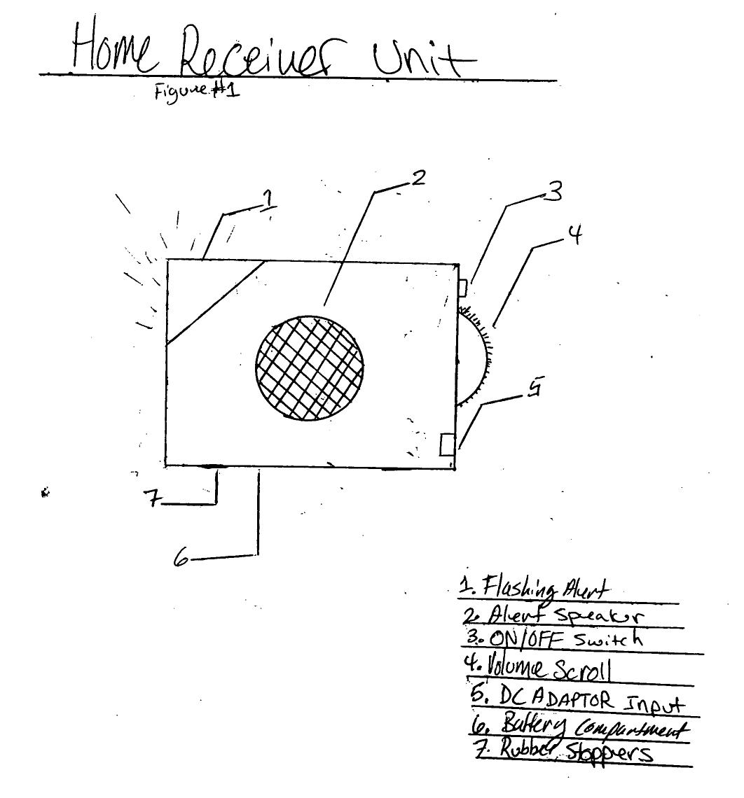

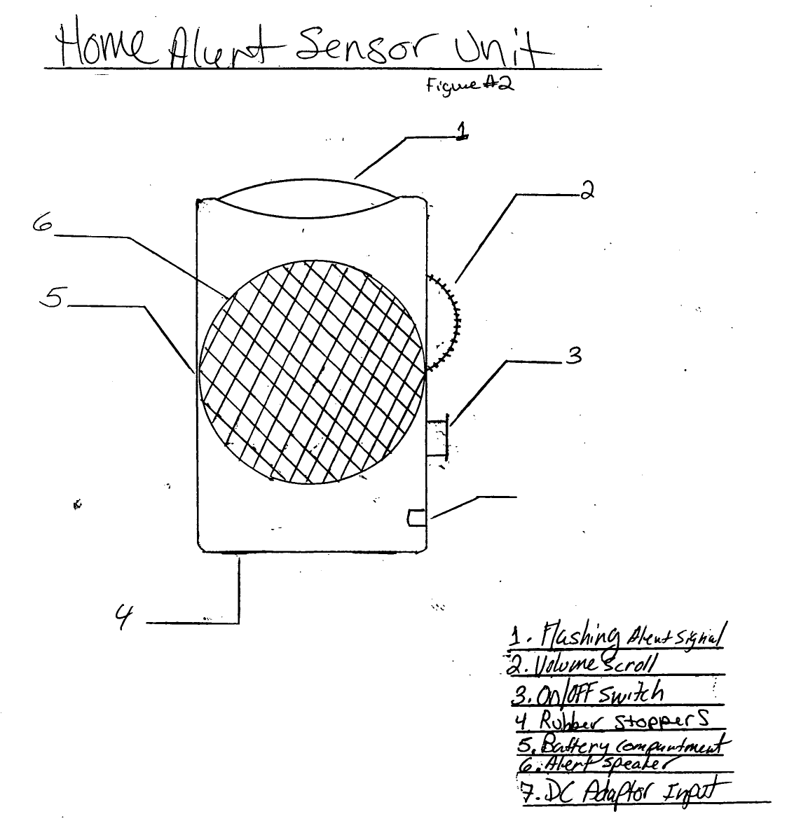

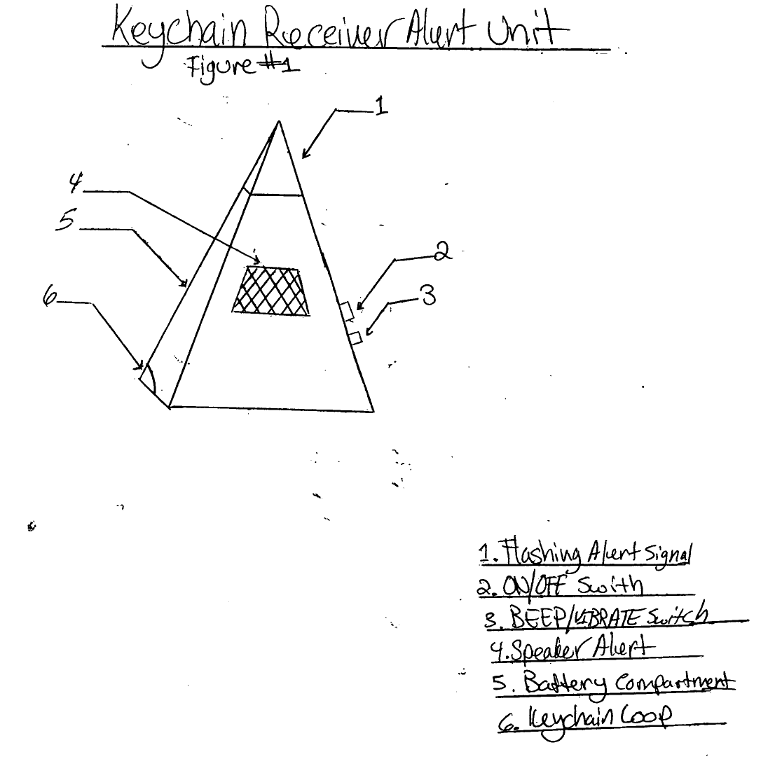

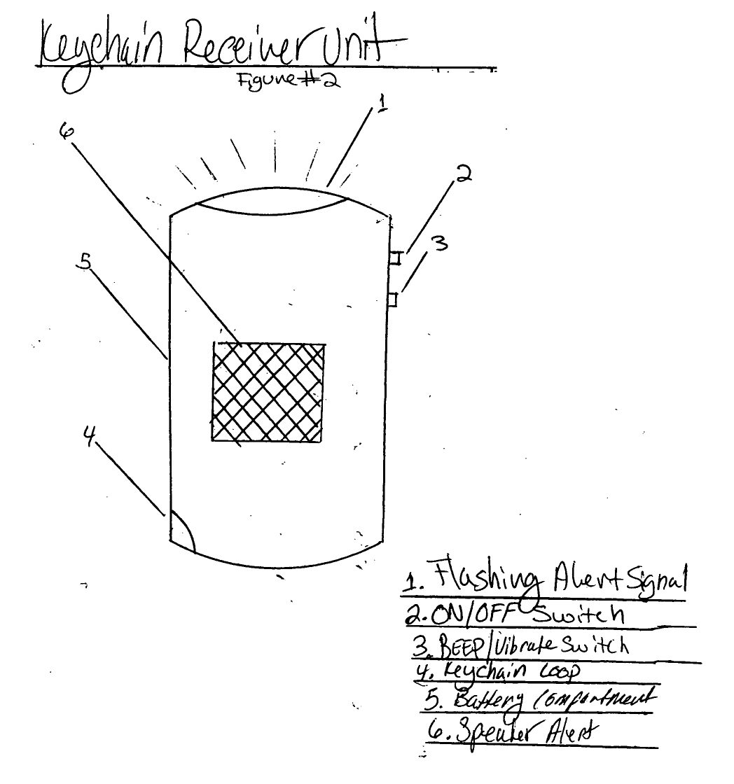

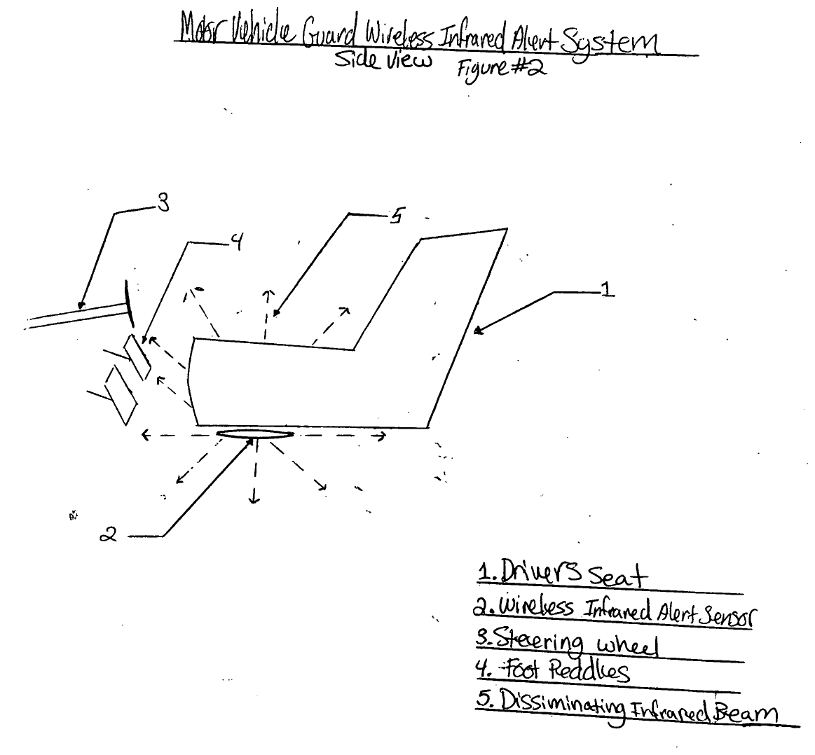

1: A device that disseminates Infrared beams in no less than two directions under a vehicles driver's seat, with a dissemination range of no less than 400 feet.

2: A vehicle anti-theft device for detecting the illegal intrusion of an automobile by monitoring the area under and around the bottom of the drivers seat, particularly facing the drivers foot peddles, using infrared dissemination covering a wide range offering an instant alert to illegal intrusions.
